(19) United States
(12) Patent Application Publication
(10) Pub. No.: US 2020/0334124 A1
(43) Pub. Date: Oct. 22, 2020

(54) ADAPTIVE PRE-PROCESSOR

(71) Applicant: INTERNATIONAL BUSINESS MACHINES CORPORATION, Armonk, NY (US)

(72) Inventors: Glenn P. Crawford, Cary, NC (US); Rocky D. McMahan, Raleigh, NC (US)

(21) Appl. No.: 16/387,927

(22) Filed: Apr. 18, 2019

(51) Int. Cl. G06F 11/34; G06F 9/54; G06F 16/11

(52) U.S. Cl. CPC G06F 11/3476; G06F 16/116; G06F 9/54

(57) ABSTRACT

Methods, systems and computer program products for generating system activity records are provided. An adaptive pre-processor includes a subsystem API for each subsystem installed in the computer system. The pre-processor receives profile records for one or more of the subsystems. Some or all of the fields in the system activity record from the system activity record generator can be output to one or more destinations, based on the profile records. The output is generated is directly consumable without an intermediate utility.

### BACKGROUND

The present invention generally relates to activity records, and more specifically, to activity records in a computer system.

A computer system generally includes a component that captures the activity of applications and subsystems and generates standardized records that are recorded in a dataset or in a logstream. There can be several types of records, each type representing a particular subsystem or event, and each record can have its own unique layout. Additionally, the actual output is in a proprietary text that is not directly consumable by common data exchange format tools, or by a markup language that is both machine and human readable. Tools have been created, by users and by 3rd party vendors, to read the activity records and convert them into a more usable format, such as a CSV file. However, some tools work with dataset data, while others work with logstream data. Additionally, a computer system can generate large volumes of event data, but the tools still have to read all the activity records to locate the ones of particular interest.

### SUMMARY

Embodiments of the present invention are directed to a computer-implemented method for an adaptive pre-processor. The method provides for receiving an interrupt indicating to read profile records from a profile library. The profile records are read and sorted by subsystem. The adaptive pre-processor generates an interrupt to notify a subsystem API to read the sorted profile records for the subsystem associated with the subsystem API.

Embodiments of the present invention are directed to a system for an adaptive pre-processor. The system includes a memory having computer readable computer instructions, and a processor for executing the computer readable instructions, that when executed, cause the processor to perform the steps of receiving an interrupt indicating to read profile records from a profile library. The profile records are read and sorted by subsystem. The adaptive pre-processor generates an interrupt to notify a subsystem API to read the sorted profile records for the subsystem associated with the subsystem API.

Embodiments of the invention are directed to a computer program product for an adaptive pre-processor, the computer program product comprising a computer readable storage medium having program instructions embodied therewith. The computer readable storage medium is not a transitory signal per se. The program instructions are executable by a processor to cause the processor to perform a method.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of a computer system for use in implementing one or more embodiments of the present invention;

FIG. 2 depicts a block diagram of the computer system of FIG. 1, with the addition of the adaptive pre-processor, according to one or more embodiments of the present invention;

FIG. 3 depicts a flow diagram of the adaptive pre-processor, according to one or more embodiments of the present invention;

FIG. 4 depicts a flow diagram of the subsystem APIs, according to one or more embodiments of the present invention;

FIG. 5 depicts a flow diagram of the adaptive pre-processor client program, according to one or more embodiments of the present invention; and

FIG. 6 depicts a block diagram of an embodiment of a computer system or cloud server in which the present invention may be implemented.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

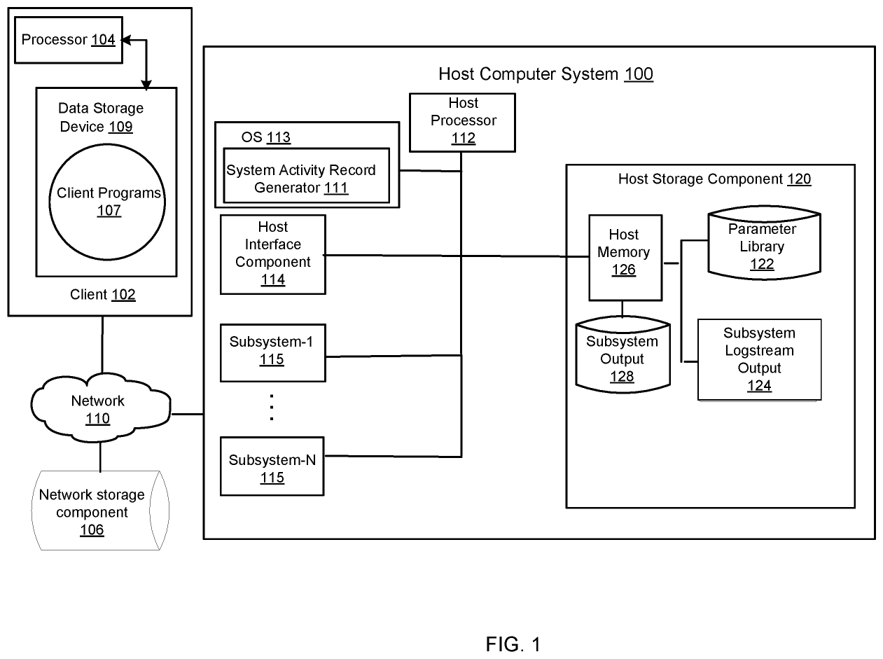

Turning to the figures, FIG. 1 depicts an example block diagram of a host computer system 100 which is in communication with one or more components. For ease of exposition, only one host computer system 100 is shown in FIG. 1. However, multiple host computer systems 100 may be distributed over a wide geographic area and be in electronic communication with each other, and with the other components shown in FIG. 1, via the network 110. For example, one or more host computer systems 100 can communicate with one or more client computers 102 via a network 110.

The host computer system 100 can include one or more components, such as a host processor 112, operating system (OS) 113, system activity record generator 111, a host interface component 114, one or more subsystems 115, and a host storage component 120. The host storage component 120 can include other components, such as host memory 126, a system parameter library 122, a subsystem output log 128, and a subsystem logstream output 124.

Each subsystem 115 provides a function of the host computer system 100, but is not necessarily part of the OS 113. Exemplary functions include a database subsystem, a security subsystem, or even a 3^{rd} party's subsystem that conforms to the architectural specifications of the host computer system 100. Each subsystem 115 generates records of its activities, under the control of the system activity record generator 111, based on such configurable parameters as time interval or specific event type. The configuration parameters for generating system activity records can be stored in the parameter library 122. The system activity record generator 111 is a component of the OS 113, and is a standardized method for writing out system activity records. The records generated by the system activity record generator 111 are written either to a subsystem output 128 dataset, or to a subsystem logstream output 124. Many types of events occur in a host computer system 100, such as I/O configuration, making a device active, and starting and terminating a job. To report each type of event, each type of system activity record has a unique format. However, in current practice, all the generated records for all the subsystems are comingled in the same file or logstream destination. In current practice, user-written exits can be added to the system activity record generator 111 to provide some customization. This customization is limited, but allows extraction of user-specified records for certain subsystems, time intervals, or events, from the comingled file or logstream destination. However, user-written or 3^{rd} party supplied utility programs are still needed in order to extract and convert the selected records to a usable format. These utilities still process all the generated records in the subsystem output 128 or subsystem logstream output 124 in order to locate and extract the desired records. Additionally, the user has the burden of ensuring compatibility between the utilities and changes introduced by subsequent release of the system activity record generator 111.

The host processor 112, the host interface component 114, and the host storage component 120 may be combined into a fewer number of components or may be separated into further components. Also, the host processor 112, the host interface component 114, and the host storage component 120 may be implemented in software or hardware, or a combination of software and hardware.

The host processor 112 is configured to control the operation of the host computer system 100. For example, the host processor 112 can initiate and manage the operations of each of the other components at the host computer system 100. The host processor 112 may also determine, based on received and/or stored data, user preferences and/or predefined settings, how the host computer system 100 operates.

The host processor 112 can be any suitable processor(s), controller(s) and/or digital signal processor(s) that can provide sufficient processing power depending on the configuration, purposes and requirements of the host computer system 100. In some embodiments, the host processor 112 can include more than one processor with each processor being configured to perform different dedicated tasks.

The host interface component 114 can be any interface that enables the host computer system 100 to communicate with other devices and systems. In some embodiments, the host interface component 114 can include at least one of a serial port, a parallel port or a USB port.

The host storage component 120 can store data and/or resources, including system parameters, user preferences, and other application parameters, in a system parameter library 122. The host storage component 120 also includes a subsystem output logs 128 where the host computer system 100 stores the results of the subsystem 115 activity, such as system events, trace data, and performance data.

The host memory 126 can store data and/or resources for providing runtime environments to the host computer system 100 and the one or more subsystems 115. The host memory 126 can include RAM, ROM, or some other data storage elements, such as disk drives. The host memory 126 can store the OS 113 that is operated by the host processor 112.

Referring still to FIG. 1, the network storage component 106 can store certain data and/or resources associated with providing runtime environments to the subsystem 115 by the host computer system 100. For example, the network storage component 106 can store the resources that are less frequently required and/or data that is not as frequently accessed by the subsystem 115 and/or the client 102 in order to more effectively allocate the storage capacity of the host storage component 120. In some embodiments, the network storage component 106 may operate as a back-up storage component for the host computer system 100 and the subsystems 115, and receive, at predefined time intervals, data already stored at the host storage component 120. In embodiments where multiple host computers 100 are provided, the network storage component 106 can store data and resources that are common to the various host computer systems 100.

The network 110 can be any network capable of carrying data, including an IP-based network for communication between the host computer system 100 and any external server or client. The network 110 can be a managed IP network administered by a service provider and implemented in a wireless fashion, e.g., using wireless protocols and technologies, such as Wi-Fi, WiMAX. The network 110 can also be a packet-switched network such as a local area network, wide area network, metropolitan area network, Internet network, or other similar type of network environment. The network 110 may be a fixed wireless network, a wireless local area network (LAN), a wireless wide area network (WAN) a personal area network (PAN), a virtual private network (VPN), intranet or other suitable network system and includes equipment for receiving and transmitting signals.

The client 102 may be any networked computing device operable to connect to the network 110 through either a wired or wireless connection. The client 102 can include such devices as an electronic tablet, a personal computer, workstation, server, and mobile device. The client 102 includes a processor 104 that is configured to control the operation of the client 102. For example, the processor 104 can initiate and manage the operations of each of the other components at the client 102 and client programs 107. The processor 104 may also determine, based on received and/or stored data, user preferences and/or predefined settings, how the client 102 operates. The data storage device 109 can store data and/or resources, including the client programs 107 and allows access by the processor 104 for their execution.

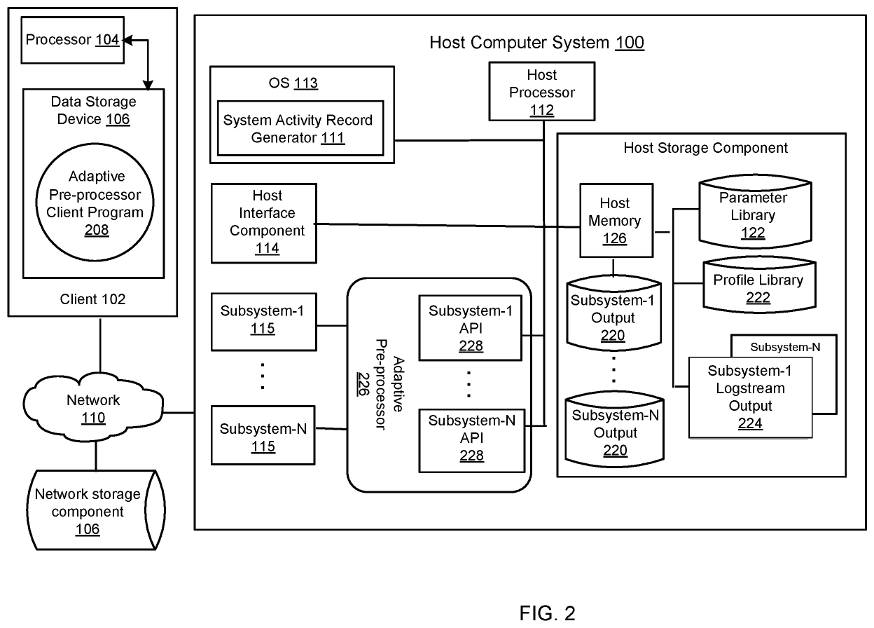

Referring now to FIG. 2, a block diagram of the computer system of FIG. 1 is depicted, with the addition of the adaptive pre-processor. Elements numbered similarly to those in FIG. 1 perform substantially the same function.

The adaptive pre-processor 226 improves the system activity record generator 111 by producing system activity records in a directly consumable format, either in addition to or instead of the current practice for generating such records described above with reference to FIG. 1.

Each subsystem 115 is associated with a subsystem API 228 in the adaptive pre-processor 226. Each subsystem API 228 is linked into its corresponding subsystem, such as the database subsystem or security subsystem. Additionally, the adaptive pre-processor 226 and the subsystem APIs 228 are linked into the system activity record generator 111 of the OS 113. This enables the dynamic changes to the profile library 222.

The format of a profile record includes a subsystem identifier, or other indicator to identify the target subsystem this profile record. The profile record further includes a record type to indicate which type of activity record is to be recorded. The profile record can indicate to continue generating the entire activity record, or only a subset of the fields. The profile record includes a timestamp, or a beginning and ending timestamp to specify for which time periods and dates that data should be generated.

The profile record includes one or more output destinations, so that the activity records can be separated by user, subsystem, or some other user-specified combination of identifiers. Therefore, the user can specify that the generated data output be stored in a user-specified file, a user-specified logstream, the subsystem output 220, the subsystem logstream 224, or any combination of destinations. A system administrator can still direct that the system activity record generator 111 continue to generate and comingle records for all the subsystems into the same file or logstream destination, as in current practice. In the profile record, the user specifies one or more output formats for each output destination, such as XML, JSON, YAML, CSV, and other serialization formats. The output can also be generated in the default format of the system activity record generator 111, either alone, or in combination with the other formats. In this way, the adaptive pre-processor 226 allows for generating customized activity records, but is transparent to the system activity record generator 111.

The profile record can specify a parameter to indicate how many times, and/or for how many days, the data output should be generated. For example, a user can specify that only a certain activity record type should be output to a certain dataset, and only be output between 06:00 and 18:00. In this way, system events can easily be captured during critical business windows, such as year-end or end-of quarter processing, or upon the introduction of a new application/subsystem. Since modifications to the profile library 222 are dynamically input to the subsystems 115, changes to generating the activity records are transparent to the system activity record generator 111.

The user creates and modifies profile records in the profile library 222 using an interface of the adaptive pre-processor client program 208. This interface can be a graphical user interface (GUI), and can include a command line interface. In the previous example, the user can temporarily stop generating the activity record type that was output between 06:00 and 18:00 without causing the record to be deleted from the profile library 222. The user can indicate this operation on the GUI. The user can manually restart generating this activity record by an indication on the GUI. Similarly, the user can indicate to temporarily stop generating this activity record for a particular number of days or hours, before dynamically beginning the generating at the end of the temporary period. This ability to temporarily stop generating one or more types of activity records can reduce system resource usage during periods of system activity, such as system upgrades, or when a subsystem is not in use, and the generated activity records would not be needed.

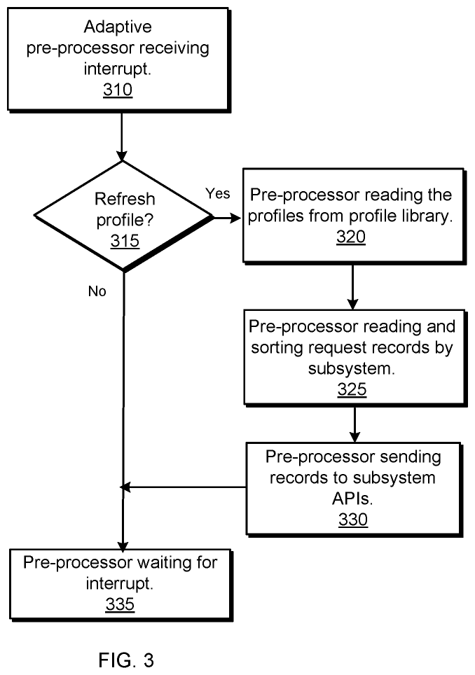

FIG. 3 depicts a flow diagram of the adaptive pre-processor 226.

At 310, the adaptive pre-processor 226 receives an interrupt from a component of the OS 113. Typically, the interrupt can be issued when the OS 113 recognizes a change to the profile library 222. The configuration can include more than one profile library 222. For example, the adaptive pre-processor 226 can read an active primary profile library 222, but have a second profile library 222 for backup or for the user to edit. Therefore, at 315, a command can generate the interrupt to notify the pre-processor 226 to either re-read the profile library 222, to switch libraries, or to re-read a profile from the profile library 222. This is in contrast to current practice, where to cause the system activity record generator 111 to re-read parameter records or to switch parameter libraries 122, a command is issued to the system activity record generator 111 to stop, another command indicates what operation to perform on the parameter library 122, and a third command restarts the system activity record generator 111.

At 320, upon receiving an interrupt, the adaptive pre-processor 226 reads the profile records from the selected profile library 222.

At 325, the adaptive pre-processor 226 prepares the profile records for use by the subsystem APIs 228. Here, the profile records are sorted in one or more ways. Primarily, the records are sorted by subsystem, but can also be sorted by user within subsystem, or a combination of record type, user and subsystem.

At 330, the adaptive pre-processor 226 sends the sorted records to the corresponding subsystem API 228. Since the subsystem APIs 228 are linked into the OS 113 by way of the adaptive pre-processor 226 and the subsystems 115, if there are profile records destined for only one subsystem 115, then only that subsystem API 228 receives an interrupt to read the profile records. Therefore, interrupting the entire system activity record generator 111 is not needed.

As in current practice, the system activity record generator 111 receives the output from each subsystem 115 and writes it to the subsystem output 220 and/or subsystem logstream output 224 as specified by the subsystem 115. However, the subsystem 115 generates the output according to the requirements of the profile records.

Processing ends at 335, where the adaptive pre-processor 226 waits for another interrupt.

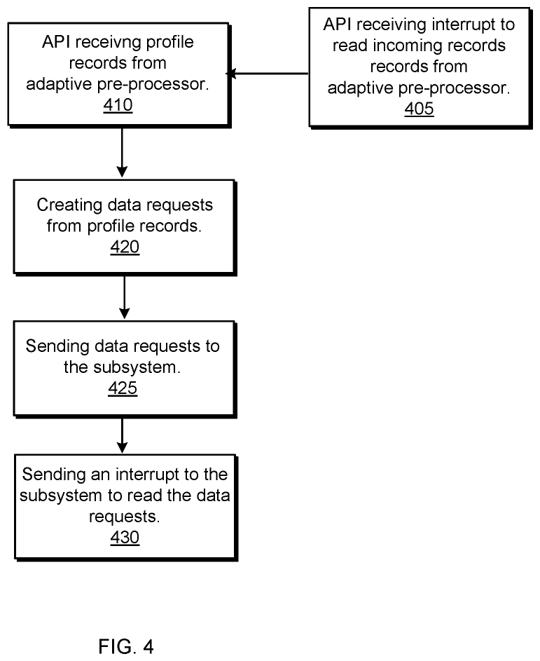

FIG. 4 depicts a flow diagram of the adaptive pre-processor 226 from the subsystem API 228 point of view.

FIG. 4 continues where FIG. 3 ends. That is, at 405 the subsystem API 228 receives an interrupt from the adaptive pre-processor 226 that there are changes to the profile records for its associated subsystem 115.

At 410, the subsystem API 228 reads the changed profile records, and at 420 formats the profile records into data requests that are compatible with the particular target subsystem 115. In this way, no modifications to the subsystem 115 are needed, since the addition of the adaptive pre-processor to the OS 113 is transparent to it.

At 425, the subsystem API 228 sends the formatted data requests to its associated subsystem 115. Processing ends at 430, where the subsystem API 228 causes an interrupt to the subsystem 115 to read the data requests.

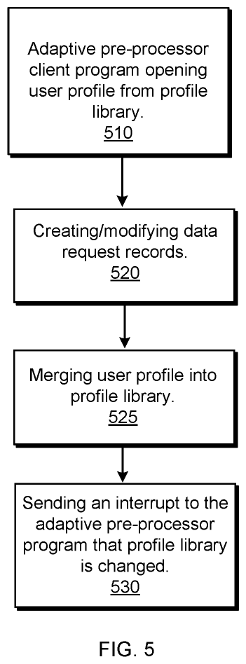

FIG. 5 depicts a flow diagram of the adaptive pre-processor client program.

At 510, a user of the adaptive pre-processor client program 208 opens the profile library 222. The user accesses the adaptive pre-processor client program 208 through an interface on the client 102. The interface can include a series of command-line commands. More typically, the interface can be a graphical user interface (GUI).

At 520, the user can create a new, or access an existing profile file. However, access to the profile library 222 is by having the proper security credentials that allow these operations. At 525, the adaptive pre-processor client program 208 merges the new or modified profile records into the existing file in the profile library, or creates a new file, if this is the first operation by the user. Processing ends at 530, when the adaptive pre-processor client program 208 sends an interrupt to the adaptive pre-processor 228 indicating that the profile library 222 is changed.

In addition to using the adaptive pre-processor client program 208 to access profile records, the user may view and update statistical usage data for the profile records. That data would be combined with other end user data to determine what data is used and when. That information could be compared against a set of system wide parameters that would define when data should or should not be generated.

Through a combination of the end users requesting only specific data, and usage statistical data the end user sends to it, the adaptive pre-processor 226 can determine which data is requested and used. If end users remove specific data (record types, subsystems, and fields) from their profile records, and/or their statistical usage information indicates that they no longer use a specific data type, the adaptive pre-processor 226 would notify the subsystem 115 through the interrupts described above.

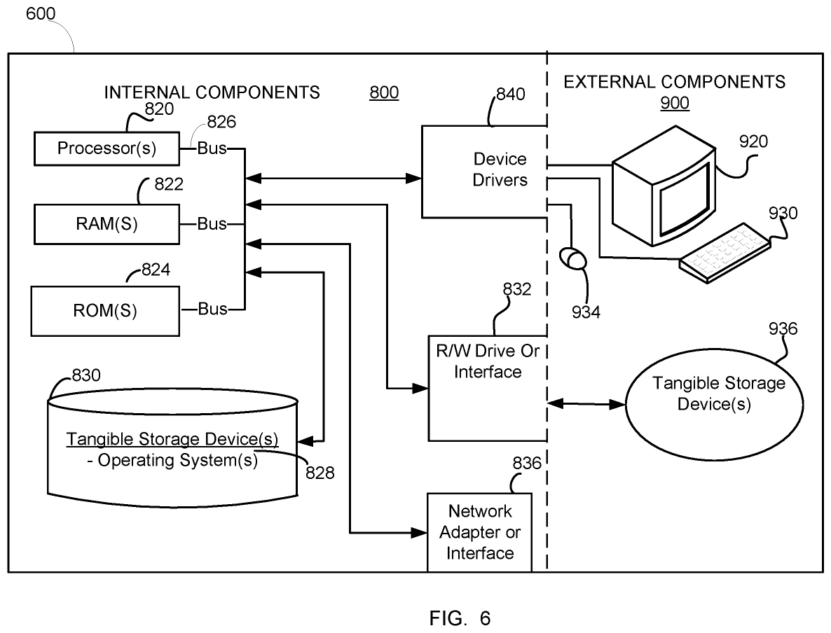

FIG. 6 is a block diagram of internal and external components of computers and servers depicted in FIG. 2 according to at least one embodiment.

It should be appreciated that FIG. 6 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The host computer system 100 and the client 102 may include respective sets of internal components 800 and external components 900 illustrated in FIG. 9. Each of the sets of internal components 800 includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and programs such as an adaptive pre-processor 228 and adaptive pre-processor client program 208, may be stored on one or more computer-readable tangible storage devices 830 for execution by one or more processors 820 via one or more RAMs 822 (which typically include cache memory). In the embodiment illustrated in FIG. 6, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 also includes a R/W drive or interface 832 to read from and write to one or more portable computer-readable tangible storage devices 936 such as a CD-ROM, DVD, memory stick, magnetic tape, magnetic disk, optical disk or semiconductor storage device. The adaptive pre-processor 228 and adaptive pre-processor client program 208 can be stored on one or more of the respective portable computer-readable tangible storage devices 936, read via the respective R/W drive or interface 832 and loaded into the respective hard drive 830.

Each set of internal components 800 may also include network adapters (or switch port cards) or interfaces 836 such as a TCP/IP adapter cards, wireless Wi-Fi interface cards, or wireless interface cards or other wired or wireless communication links. The software components of the adaptive pre-processor 228 and adaptive pre-processor client program 208 can be downloaded from an external computer (e.g., server) via a network (for example, the Internet, a local area network or other, wide area network) and respective network adapters or interfaces 836. From the network adapters (or switch port adaptors) or interfaces 836, the software components of the adaptive pre-processor 228 and adaptive pre-processor client program 208 are loaded into the respective hard drive 830. The network may comprise copper wires, optical fibers, wireless transmission, routers, firewalls, switches, gateway computers and/or edge servers.

Each of the sets of external components 900 can include a computer display monitor 920, a keyboard 930, and a computer mouse 934. External components 900 can also include touch screens, virtual keyboards, touch pads, pointing devices, and other human interface devices. Each of the sets of internal components 800 also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by software or hardware-based systems that perform the specified functions or acts or carry out combinations of computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving an interrupt indicating to read profile records from a profile library;
reading and sorting the profile records by subsystem; and
generating an interrupt to notify a subsystem API to read the sorted profile records for the subsystem associated with the subsystem API.

2. The computer-implemented method of claim 1, further comprising:
in response to receiving the interrupt, the subsystem API reading the profile records;
formatting each of the profile records into one or more data requests in an input format required by the subsystem; and
generating an interrupt to notify the subsystem to read the one or more data requests.

3. The computer-implemented method of claim 2, further comprising:
in response to receiving the interrupt to read the one or more data requests, stopping generating output based on a current set of data requests; and
beginning generating output based on the received one or more data requests.

4. The computer-implemented method of claim 2, wherein only the subsystem receiving the one or more data requests is interrupted.

5. The computer-implemented method of claim 3, wherein the output of the generated data request is in the default format of a system activity record generator and in either XML or CSV.

6. The computer-implemented method of claim 1, wherein each of the profile records specifies that the output of the generated data request is in XML or CSV.

7. The computer-implemented method of claim 6, wherein each of the profile records include one or more output destinations for each generated data request.

8. A system comprising:
a processor communicatively coupled to a memory, the processor configured to:
receive an interrupt indicating to read profile records from a profile library;
read and sort the profile records by subsystem; and
generate an interrupt to notify a subsystem API to read the sorted profile records for the subsystem associated with the subsystem API.

9. The system of claim 8, further comprising:
in response to receiving the interrupt, the subsystem API reading the profile records;
formatting each of the profile records into one or more data requests in an input format required by the subsystem; and
generating an interrupt to notify the subsystem to read the one or more data requests.

10. The system of claim 9, further comprising:
in response to receiving the interrupt to read the one or more data requests, stopping generating output based on a current set of data requests; and
beginning generating output based on the received one or more data requests.

11. The system of claim 9, wherein only the subsystem receiving the one or more data requests is interrupted.

12. The system of claim 10, wherein the output of the generated data request is in the default format of a system activity record generator and in either XML or CSV.

13. The system of claim 8, wherein each of the profile records specifies that the output of the generated data request is in XML or CSV.

14. The system of claim 13, wherein each of the profile records include one or more output destinations for each generated data request.

15. A computer program product comprising a non-transitory computer readable storage medium readable by a processing circuit and storing instructions for execution by the processing circuit for performing a method comprising:
receiving an interrupt indicating to read profile records from a profile library;
reading and sorting the profile records by subsystem; and
generating an interrupt to notify a subsystem API to read the sorted profile records for the subsystem associated with the subsystem API.

16. The computer program product of claim 15, further comprising:
in response to receiving the interrupt, the subsystem API reading the profile records;
formatting each profile record into one or more data requests in an input format required by the subsystem; and
generating an interrupt to notify the subsystem to read the one or more data requests.

17. The computer program product of claim 16, further comprising:
in response to receiving the interrupt to read the one or more data requests, stopping generating output based on a current set of data requests; and
beginning generating output based on the received one or more data requests.

18. The computer program product of claim 16, wherein only the subsystem receiving the one or more data requests is interrupted.

19. The computer program product of claim 15, wherein the output of the generated data request is in the default format of a system activity record generator and in either XML or CSV.

20. The computer program product of claim 15, wherein each of the profile records specifies that the output of the generated data request is in XML or CSV, and is directly consumable without an intermediate utility.
